(19) United States
(12) Patent Application Publication
(10) Pub. No.: US 2022/0164851 A1
(43) Pub. Date: May 26, 2022

(54) METHOD AND APPARATUS FOR PROVIDING INFORMATION ABOUT SIMILAR ITEMS BASED ON MACHINE LEARNING

(71) Applicant: EMRO CO., LTD., Seoul (KR)

(72) Inventors: Jae Min Song, Seoul (KR); Kwang Seob Kim, Seoul (KR); Ho Jin Hwang, Seoul (KR); Jong Hwi Park, Gyeonggi-do (KR)

(21) Appl. No.: 17/456,129

(22) Filed: Nov. 22, 2021

(30) Foreign Application Priority Data
Nov. 23, 2020 (KR) 10-2020-0158142

(51) Int. Cl. G06Q 30/06

(52) U.S. Cl. CPC G06Q 30/0629

(57) ABSTRACT

Provided is a method of providing information on similar items based on machine learning, the method including receiving information on a target item, generating a target vector based on a character string corresponding to the information on the target item using a machine learning model, identifying one or more vector sets respectively corresponding to a plurality of items derived through the machine learning model, providing information on one or more items corresponding to one or more vectors in the one or more vector sets, the one or more vector having similarity value with the generated target vector greater than or equal to a preset threshold value.

### CROSS-REFERENCE TO RELATED APPLICATION(S)

Any and all applications for which a foreign or domestic priority claim is identified in the Application Data Sheet as filed with the present application are hereby incorporated by reference under 37 CFR 1.57. .

This application claims the benefit of Korean Patent Application No. 10-2020-0158142, filed on Nov. 23, 2020, in the Korean Intellectual Property Office, the disclosure of which is incorporated herein by reference.

### BACKGROUND

### Field

The present disclosure relates to a method and apparatus for providing information about similar items based on machine learning. More particularly, the present disclosure relates to a method of providing information about one or more items having similar vector values using a learning model created by performing machine learning on received information about a target item, and an apparatus using the same.

### Description of the Related Technology

With the development of machine learning and deep learning techniques in recent years, language processing research and development have been actively conducted to extract and utilize meaningful information from huge amounts of text through machine learning and deep learning-based natural language processing.

Document in the related art: Korean Patent Application Publication No. 10-2020-0103182.

The document in the related art discloses a method of providing similar goods based on deep learning. As such, companies utilize machine learning technology to provide similar goods for input data, but the document in the related art is limited to recommending goods based on a goods image or keyword extraction and does not disclose a method of creating a specific predictive model or a method of providing similar items specialized for inventory management.

Companies need to standardize, integrate, and manage various types of pieces of information produced by the companies to improve work efficiency and productivity. In particular, there is a need for a method and system for systematically managing information about items and providing information about an item similar to a new item to avoid duplicate purchases and identify statuses of similar items possessed in the companies.

### SUMMARY

An aspect provides information about an item similar to a target item by configuring a each of vector set based on character string information on a plurality of items and text information on the target item using machine learning, and providing information on the item similar to the target item by comparing the vector for the target item with the vector set for the plurality of items.

Another aspect also provides a method and apparatus for generating a character string on the basis of an attribute related to an item and classifying a plurality of items on the basis of vector information of the generated character string.

The technical object to be achieved by the present example embodiments is not limited to the above-described technical objects, and other technical objects which are not described herein may be inferred from the following example embodiments.

According to an aspect, there is provided a method of providing information on similar items based on machine learning, the method including receiving information on a target item, generating a target vector on the basis of a character string corresponding to the information on the target item using a machine learning model, identifying one or more vector sets respectively corresponding to a plurality of items derived through the machine learning model, providing information on one or more items corresponding to one or more vectors in the one or more vector sets, the one or more vector having similarity value with the generated target vector greater than or equal to a first threshold value.

According to another aspect, there is provided an apparatus for providing information on similar items based on machine learning, the apparatus including a memory configured to store at least one instruction, and a processor configured to execute the at least one instruction to receive information on a target item, generate a target vector on the basis of a character string corresponding to the information on the target item using a machine learning model, identify one or more vector sets respectively corresponding to a plurality of items derived through the machine learning model, provide information on one or more items corresponding to one or more vectors in from the one or more vector sets, the one or more vector having similarity value with the generated target vector greater than or equal to a first threshold value.

According to still another aspect, there is provided a computer-readable non-transitory recording medium recording a program for executing a method of providing information on similar items based on machine learning on a computer, and the method of providing information on similar items based on machine learning includes receiving information on a target item, generating a target vector on the basis of a character string corresponding to the information about the target item using a machine learning model, identifying one or more vector sets respectively corresponding to a plurality of items derived through the machine learning model, providing information on one or more items corresponding to one or more vectors in the one or more vector sets, the one or more vector having similarity value with the generated target vector greater than or equal to a first threshold value.

Specific details of other example embodiments are included in the detailed description and drawings.

According to an example embodiment of the present specification, inventory management of items can be performed consistently by recommending information on similar items among the previously input item based on previously input item information and newly input item information.

Further, according to an example embodiment of the present specification, even when information on some attributes of a new item is selectively input, a similarity with previously input item information can be determined based on some of the input information, so that input efficiency can increase, and when there are many similar items, information on the items that have not been input may be additionally input, so that user convenience can be improved along with more detailed inventory management.

Further, according to an example embodiment of the present specification, a weight can be assigned to each of the information on a plurality of attributes, so that, even when there are multiple overlapping items in some attributes, different similarity results can be produced, and the items having the same some attributes can be managed separately by different item information.

It should be noted that effects of the present disclosure are not limited to the above-described effects, and other effects that are not described herein will be clearly understood by those skilled in the art from the description of the claims.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram for describing an item management system according to an example embodiment of the present disclosure;

FIG. 2 is a diagram for describing a method of inputting information about a target item according to an example embodiment;

FIG. 3 is a diagram for describing a method of managing information about an item according to an example embodiment of the present disclosure;

FIGS. 4 and 5 are diagrams for describing a method of performing vectorization on information about an item, according to an example embodiment;

FIG. 6 is a diagram for describing a method of generating a vector to be included in a word embedding vector table according to an example embodiment;

FIG. 7 is a diagram for describing a method of pre-processing information about an item before performing item classification, according to an example embodiment;

FIG. 8 is a diagram for describing parameters that may be adjusted when a learning model related to the item classification is generated, according to an example embodiment;

FIGS. 9 to 11 are diagrams for describing a similarity result of items according to an example embodiment;

FIG. 12 is a diagram for describing a method of providing information about similar items according to an example embodiment;

FIG. 13 is a flowchart for describing a method of providing information about similar items based on machine learning according to an example embodiment; and

FIG. 14 is a block diagram for describing an apparatus for providing information about similar items based on machine learning according to an example embodiment.

### DETAILED DESCRIPTION

Terms used in example embodiments are general terms that are currently widely used while their respective functions in the present disclosure are taken into consideration. However, the terms may be changed depending on the intention of those of ordinary skilled in the art, legal precedents, emergence of new technologies, and the like. Further, in certain cases, there may be terms arbitrarily selected by the applicant, and in this case, the meaning of the term will be described in detail in the corresponding description. Accordingly, the terms used herein should be defined based on the meaning of the term and the contents throughout the present disclosure, instead of the simple name of the term.

Throughout the specification, when a part is referred to as including a component, unless particularly defined otherwise, it means that the part does not exclude other components and may further include other components.

The expression “at least one of a, b, and c,” should be understood as including only a, only b, only c, both a and b, both a and c, both b and c, or all of a, b, and c.

Example embodiments of the present disclosure that are easily carried out by those skilled in the art will be described in detail below with reference to the accompanying drawings. The present disclosure may, however, be implemented in many different forms and should not be construed as being limited to the example embodiments described herein.

Example embodiments of the present disclosure will be described in detail below with reference to the drawings.

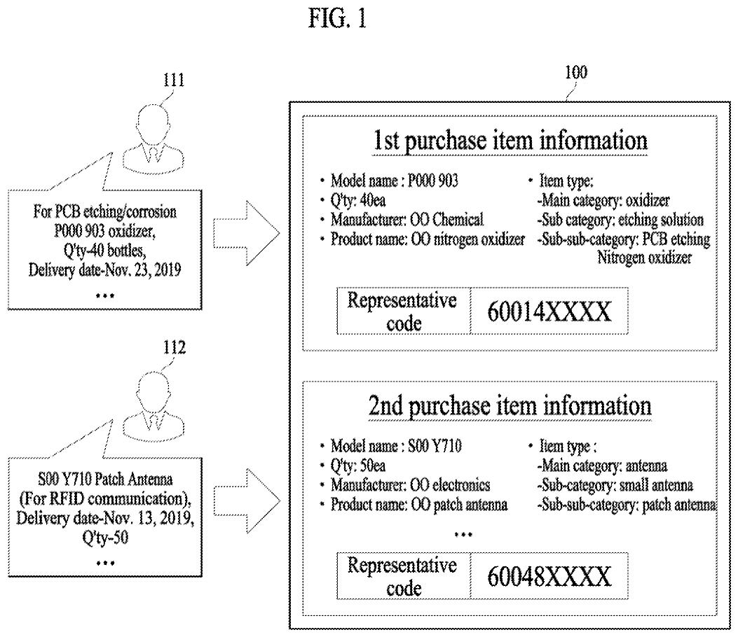

FIG. 1 is a diagram for describing an item management system according to an example embodiment of the present disclosure.

When information about items are received, an item management system 100 according to an example embodiment of the present disclosure may process information about each item in a unified format and assign codes to the items to which a separate code is not assigned, and the code that is initially assigned to a specific item may be a representative code. In an example embodiment, the item information may include a general character string and may be a character string including at least one delimiter. In an example embodiment, the delimiter may include, but is not limited thereto, a space character and punctuation marks and may include a character capable of distinguishing between specific items.

Referring to FIG. 1, the item management system 100 may receive purchase item information from a plurality of managers 111 and 112. In an example embodiment, the purchase item information may be a purchase request for purchasing the corresponding item, and in this case, the purchase item information received from the plurality of managers 111 and 112 may be different in format, and thus there may be a difficulty in integrating and managing a plurality of purchase requests.

Accordingly, the item management system 100 according to an example embodiment may perform machine learning on the basis of existing item information, process the purchase item information received from the plurality of managers 111 and 112 in a predetermined format according to learning results generated through the machine learning, and store the processed item information.

For example, the item information provided by a first manager 111 may include only a specific model name (e.g., “P000 903”) and a use (for printed circuit board (PCB) etching/corrosion) of the item, but may not include information required for classifying the item (e.g., information about a main-category, a sub-category, and a sub-sub-category). In this case, when the item information provided by the first manager 111 is received, the item management system 100 may classify the item and attribute information of the item on the basis of a result of the machine learning, and may store and output a classification result.

Further, even when the order of all attribute items included in the item information provided by the first manager 111 is different from the order of all attribute items included in the item information provided by a second manager 112, the item management system 100 may classify and store the attribute information by identifying each of the attribute items. Meanwhile, in an example embodiment, the first manager 111 and the second manager 112 may be the same manager. Further, even when information about the same item are recorded differently due to misspellings or a display form, by determining a similarity between the input item information according to the learning result of the learning model, an operation such as determining the similarity between the received item and the already input item or assigning a new representative code to the received item may be performed.

Accordingly, in the item management system 100 according to an example embodiment, the efficiency of managing information about each item may be increased.

Meanwhile, in FIG. 1, the description is provided on the assumption that the item management system 100 is for the purpose of integrally managing information related to an item purchase, but the use of the item management system 100 is not limited to the item purchase, and the item management system 100 may also be used for reclassifying the corresponding information based on the already input item information. Thus, it is clear for those skilled in the art that the example embodiment of the present specification may be applied to all systems for integrating and managing a plurality of items. In other words, it is clear that the example embodiment of the present specification may be utilized in processing previously-stored item information as well as in requesting a purchase of an item.

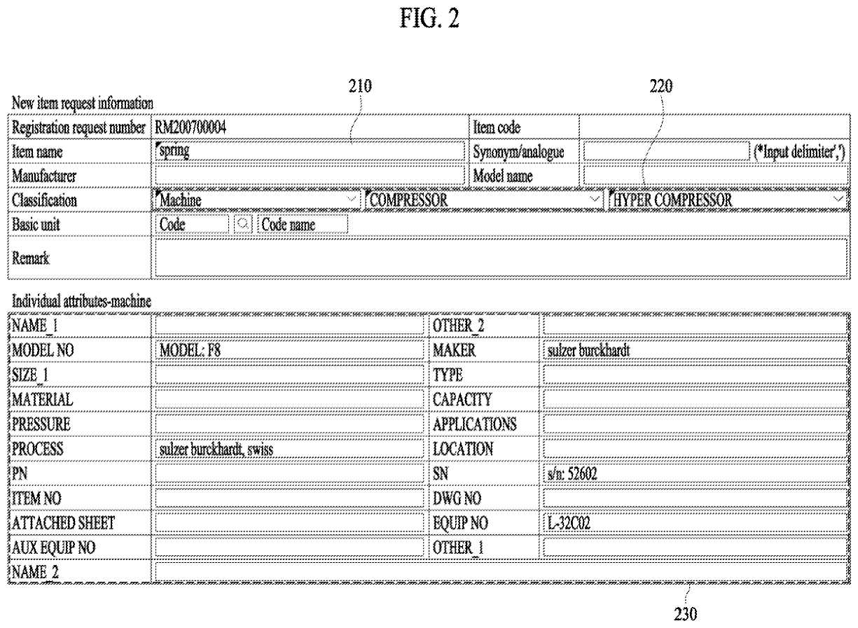

FIG. 2 is a diagram for describing a method of inputting information about a target item according to an example embodiment.

The item management system according to an example embodiment may receive information about an item from a user. The information about the item may include required attribute information about the item and optional attribute information about the item. The required attribute information may include at least necessary information to classify a plurality of items. For example, the required attribute information may include an item name and item classification information of the item. Here, the item classification information may be information classified into a main-category, a sub-category, and a sub-sub-category as a product type to which the corresponding item belongs.

FIG. 2 illustrates an item name 210 and item classification information 220 of the required attribute information. According to an example embodiment, unlike optional attribute information 230, a separate mark may be added to an entry so that the required attribute information may be input as mandatory. For example, in FIG. 2, a mark with a different color is inserted in an upper left corner of an entry in which the required attribute information is input to indicate that the corresponding item is an item input as mandatory.

According to an example embodiment, the optional attribute information may include optional information that may help to more precisely distinguish the plurality of items but is not the information necessarily required for item classification. For example, the optional attribute information may include a manufacturer, a model name, a size, a strength, a material, a capacity, a location, a type, and the like. The optional attribute information may be derived differently according to the item classification information. For example, when the main-category of the item classification information is “machine”, attributes that a machine type item may represent, for example, a material, a strength, a capacity, auxiliary equipment information, and the like, may be represented as the optional attribute information.

In FIG. 2, the optional attribute information 230 may be shown in a separate area from that of the required attribute information. All of the optional attribute information 230 does not need to be input, and the user may input information about desired items. For example, in FIG. 2, for the target item, information about a model name, an item processing company, a manufacturer, a serial number, and an equipment number among the optional attribute information 230 may be input.

According to an example embodiment, a unique item code may be assigned to each item. The item code may be a unique code automatically assigned by a server on the basis of the information about the item. Alternatively, the item code may be a code that the user designates and inputs when inputting information about the item. Accordingly, unless the item is the same item, the item code may be different for each item.

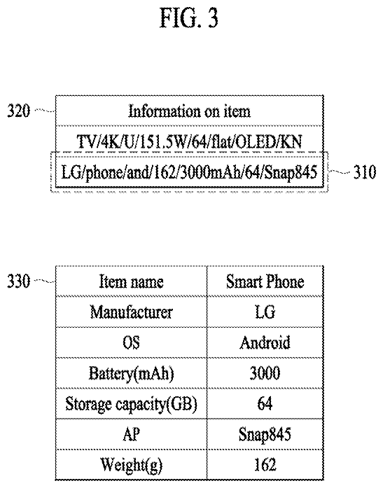

FIG. 3 is a diagram for describing a method of managing information about an item according to an example embodiment of the present disclosure.

When information about an item is received, the item management system according to an example embodiment may classify attribute information in the received information on the basis of each attribute item. Here, the information about the item may include a plurality of attribute information, and the attribute information may be classified according to the attribute entry. More specifically, the information about the item may be a character string including a plurality of attribute information, and the item management system may classify the information about the item to derive information corresponding to each attribute.

Referring to table 320, the item management system may receive information about a plurality of items, which have different formats. For example, the item management system may perform crawling or receive the information about the plurality of items from a customer database, or may receive the information about the plurality of items through a user's input. At this time, this may be in the state in which attribute items (an item name, a manufacturer, an operating system (OS), and the like) included in the information about the item are not identified.

In this case, the item management system according to an example embodiment may classify each of the attribute information included in the information about the item through machine learning. For example, item information 310 of table 320 may be classified into pieces of attribute information according to various attribute items including an item name in table 330. In an example embodiment, the management system may determine which attribute corresponds to each information classified according to a learning model, check the item to which the character string for one item corresponds based on a value corresponding to each attribute, and check information about the item of the same category, thereby collectively managing such items.

According to the item management system, information corresponding to each attributes may be derived from the information about the item, divided, and stored, and even when a character string corresponding to the information is input later, the corresponding character string may be analyzed to check the corresponding attribute value, classified, and stored.

Thus, the item management system according to an example embodiment may standardize information about items and manage main attribute information and thus may classify the items that are similar or overlapping, thereby increasing the convenience of data maintenance.

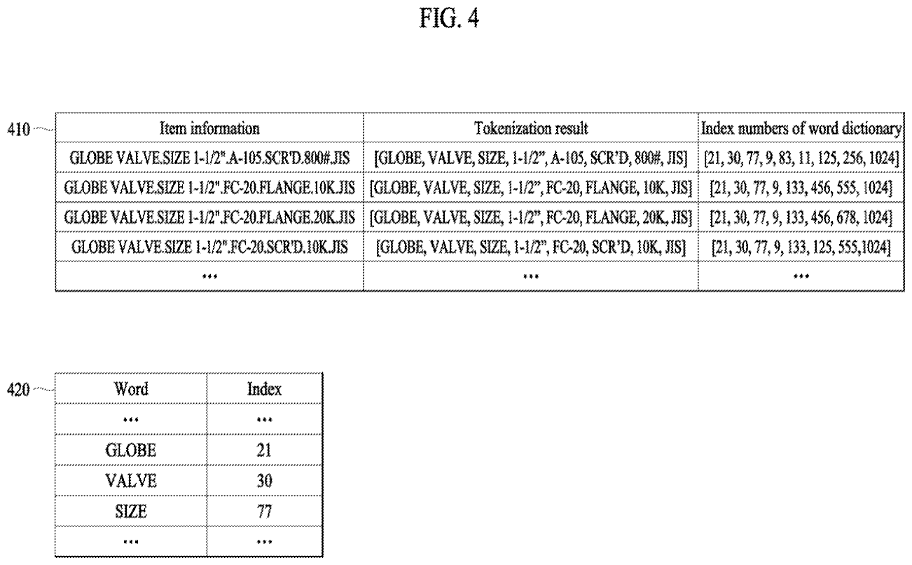

According to an example embodiment, before receiving the information about the item as a character string like the item information 310 of table 320, the information about the item may be input for each item for the attribute information as shown in FIG. 2. In this case, at least some information about the plurality of attributes may be generated by being concatenated in order to represent the information about the item as the character string corresponding to the item information. For example, the information about the item may be received as the required attribute information and the optional attribute information. In this case, the character string corresponding to the item information may be generated by concatenating at least some of the optional attribute information and the required attribute information depending on the order according to the learning model. According to an example embodiment, a delimiter may be included between each attribute information to form the character string. For example, the information about the item may be configured as a single character string by classifying the attribute information through various types of delimiters such as “|”, a special character, and a space character. The character string is generated on the basis of the order according to the learning model by machine learning, and a method of generating the learning model will be described in detail below with reference to FIGS. 4 to 8.

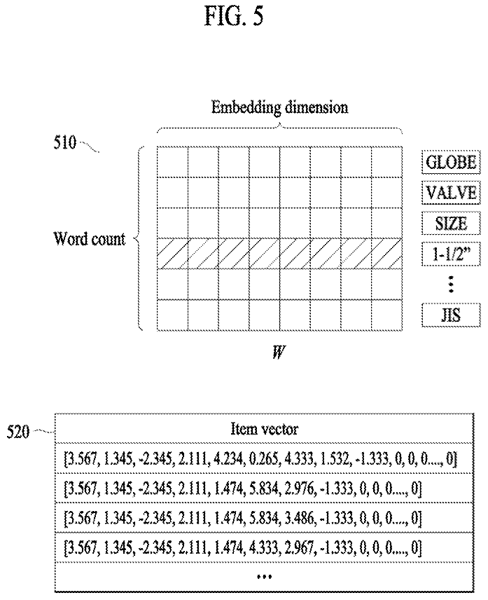

FIGS. 4 and 5 are diagrams for describing a method of performing vectorization on information about an item, according to an example embodiment.

An apparatus for classifying an item of the present disclosure may be an example of the item management system. In other words, an example embodiment of the present disclosure may relates to the apparatus for classifying an item on the basis of information about an item. The item classification apparatus may generate a vector by tokenizing information about items into units of words.

According to an example embodiment, when information about an item is expressed as a character string, the attribute information is generated by being concatenated depending on the order according to a learning model, so that the order in which the information about the item is tokenized may be based on the order according to the learning model. On the other hand, when information about a specific order among the order according to the learning model is not input in the information about the item, the character string may be generated by including a character corresponding to a blank in the specific order. For example, non-received attribute information may be replaced with space character values consisting of “0” in the character string.

Referring to table 410, in the case in which information about an item is [GLOBE VALVE.SIZE 1½″. A-105.SCR′D.800#JIS], the information about the item may be tokenized into units of each word, and on the basis of the tokenization result [GLOBE, VALVE, SIZE, 1½″, A-105, SCR′D, 800#, JIS], it is possible to find an index number corresponding to each token from a word dictionary. Thus, index numbers of the word dictionary of the corresponding tokenization result may be [21, 30, 77, 9, 83, 11, 125, 256, 1024].

The index numbers of the word dictionary may be defined as information in which the item information are listed as index values of words based on the word dictionary obtained by indexing words extracted from an entire training data set. In addition, the index numbers of the word dictionary may be used as key values for finding vector values of words from a word embedding vector table.

Here, in an example embodiment, the tokenization in units of words may be performed on the basis of at least one of delimiters such as a spacing and a punctuation mark. Since the tokenization may be performed on the basis of at least one delimiter, the token may also be applied similarly to an attribute value that is replaced by a space character.

According to an example embodiment, pre-processing of removing characters irrelevant to similarity analysis may be performed on the character string corresponding to the item information. For example, the character string may be configured by deleting a special character or a spacing that is not used in distinguishing attributes. Alternatively, the pre-processing may be performed on the character string corresponding to the item information by capitalizing all characters in the case of English. Through such a pre-processing process, the tokenization of the item information may become useful.

As described above, the tokenization may be performed on the basis of at least one of a spacing and a punctuation mark, and the tokenized word may include information representing the corresponding item. Alternatively, the tokenized word may not be a word written in a typical dictionary or may be a word having information to represent an item, but is not limited thereto, and may include words that do not have an actual meaning.

To this end, the item classification apparatus may store a word dictionary in table 420. The index number corresponding to “GLOBE” in table 410 may be “21” as shown in table 420, and accordingly, as the index number of the word dictionary corresponding to “GLOBE,” “21” may be stored. Similarly, in the case of “VALVE,” “30” may be stored as the index number, and in a case of “SIZE,” “77” may be stored as the index number.

Meanwhile, a vector corresponding to each word may be determined on the basis of the word embedding vector table in which each word included in the information about the item is mapped to each vector. In order to generate the word embedding vector table, a word2vec algorithm may be utilized, but the method of generating vectors is not limited thereto. Of the word2vec algorithm, a word2vec skip-gram algorithm is a technique of predicting several surrounding words of each word constituting a sentence using the each word. For example, when a window size of the word2vec skip-gram algorithm is three, a total of six words may be output when a single word is input. Meanwhile, in an example embodiment, by changing the window size, a vector value may be generated in various units for the same item information, and learning may be performed in consideration of the generated vector values.

The word embedding vector table 510 may be in the form of a matrix composed of a plurality of vectors each represented as an embedding dimension as shown in FIG. 5. In addition, the number of rows in the word embedding vector table may correspond to the number of words included in information about a plurality of items. An index value of the word may be used for finding a vector value of the corresponding word from the word embedding vector table. In other words, a key value of the word embedding vector table utilized as a lookup table may be the index value of the word. Meanwhile, each item vector may be illustrated as shown in table 520.

Meanwhile, in the case in which the tokenization is performed in units of words, when a word, which is not included in the word embedding vector table, is input, since a vector corresponding to the word does not exist, it may be difficult to generate the vector corresponding to the information about the item. In addition, in the case in which several words, which do not exist in the word embedding vector table, are included in the information about the item, item classification performance may degrade.

Accordingly, the item management system according to an example embodiment may generate the word embedding vector table related to the information about the items using sub-words of each word included in the information about the item.

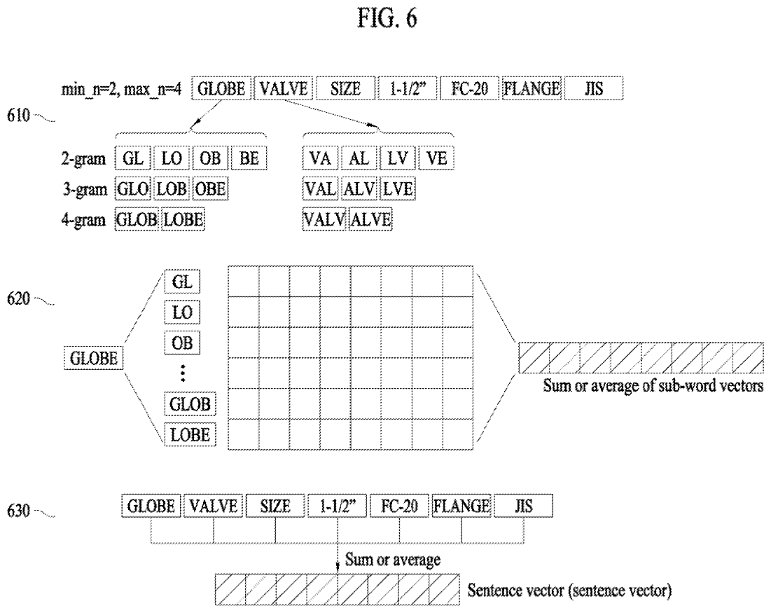

FIG. 6 is a diagram for describing a method of creating a vector to be included in the word embedding vector table according to an example embodiment.

Referring to first model 610, after the tokenization is performed in units of words, sub-word vectors respectively corresponding to sub-words of each word may be generated. For example, with respect to a word “Globe”, when 2-gram sub-words are generated, four sub-words “GL,” “LO,” “OB,” and “BE” may be generated, and when 3-gram sub-words are generated, three sub-words “GLO,” “LOB,” and “OBE” may be generated. In addition, when 4-gram sub-words are generated, two sub-words “GLOB” and “LOBE” may be generated.

Referring to second model 620, the item classification apparatus according to an example embodiment may extract sub-words of each word, and generate a sub-word vector corresponding to each sub-word by performing machine learning on the sub-words. In addition, a vector of each word may be generated by summing the vector of each sub-word. Thereafter, a word embedding vector table of second model 620 may be generated using the vector of each word. Meanwhile, the vector of each word may be generated on the basis of an average of the sub-word vectors, as well as the sum of the sub-word vectors, but the present disclosure is not limited thereto.

Meanwhile, when the vector of each word is generated using the sub-word vectors, item classification performance may be maintained even when a misspelling is included in input item information.

Thereafter, referring to third model 630, the item classification apparatus may generate a sentence vector corresponding to the information about the item by summing or averaging the word vectors each corresponding to each word. At this time, an embedding dimension of the sentence vector is the same as an embedding dimension of each word vector. That is, a length of the sentence vector and a length of each word vector are the same.

Here, a character count and type of the sub-words are not limited thereto, and it is clear for those skilled in the art that the character count and type of the sub-words may vary depending on system design requirements.

Meanwhile, when classifying an item, the item classification apparatus according to an example embodiment may generate a vector by assigning a weight to each word included in information about the item.

For example, information about a first item may be [GLOBE, VALVE, SIZE, 1½″, FC-20, P/N:100, JIS], and information about a second item may be [GLOVE, VALV, SIZE, 1⅓″, FC20, P/N:110, JIS]. In this case, when a vector corresponding to the information about the item is generated by assigning weights to words related to a size and a part number among attribute items included in the information about the item, a similarity between the information about the two items different in size and part number may be lowered. In addition, when the vectors corresponding to the information about the items are different from each other due to a misspelling and omission of a special character or the like in items with relatively low weights, a similarity between the information about the two items may be relatively high. Meanwhile, in an example embodiment, the character to which the weight is applied may be differently set according to the type of the item. In an example embodiment, for items that have the same item name but need to be classified as different items according to attribute values, a high weight may assigned to the corresponding attribute value, and based on this, a similarity may be determined. In addition, in the learning model, attribute values that need to be assigned such a high weight may be identified, and based on the classification data, when items with the same name have different attribute information, the high weight may be assigned to such attribute information.

Accordingly, the item management system according to an example embodiment may further improve the item classification performance by generating the vector after assigning a weight to each attribute included in the information about the item.

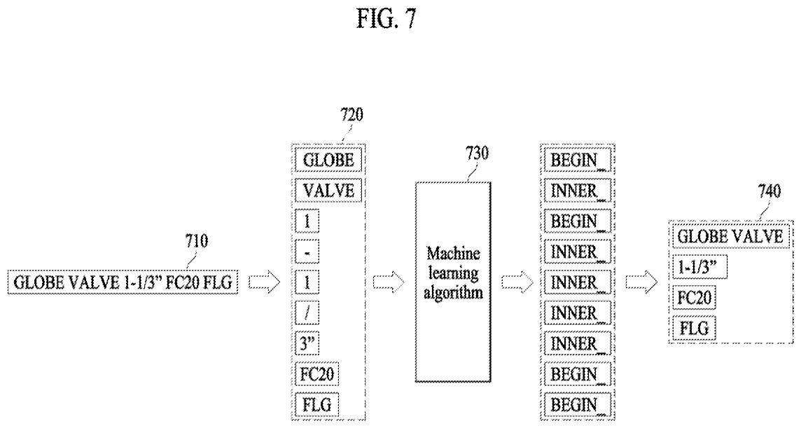

FIG. 7 is a diagram for describing a method of pre-processing the information about the item before performing the item classification, according to an example embodiment.

According to an example embodiment, in order to pre-process the information about the item, a character irrelevant to similarity analysis such as a special character or a spacing that is not used in distinguishing attributes may be removed, or all characters may be capitalized in the case of English. Meanwhile, each attribute information included in the information about the item may be information classified using a delimiter, and may also be composed of a continuous character without a delimiter. When each attribute item included in the information about the item is not distinguished and input as a continuous character, it may be difficult to identify each attribute entry without pre-processing. In this case, the item classification apparatus according to an example embodiment may pre-process the information about the item before performing the item classification.

Specifically, before calculating a similarity between the information about the items, the item classification apparatus according to an example embodiment may perform the pre-processing to identify each word included in the information about the item through machine learning.

Referring to FIG. 7, when the information about the item is input as a continuous character string 710, the item classification apparatus according to an example embodiment may classify characters in the continuous character string 710 into units for tagging on the basis of a space character or a specific character. Here, a character string 720 of units for tagging is defined as a character string having a length less than that of a character string 740 of a tokenization unit, and refers to units to which a start tag “BEGIN_,” a contiguous tag “INNER_,” and an end tag “O_” are added.

After that, the item classification apparatus may add the tag to each unit for tagging of the character string 720 using a machine learning algorithm 730. For example, in FIG. 7, the “BEGIN_” tag may be added to “GLOBE”, and the “INNER_” tag may be added to “/”.

Meanwhile, the item classification apparatus may recognize from a token to which the start tag “BEGIN_” is added to a token to which the end tag “O” is added as one word, or recognize from the token to which the start tag “BEGIN_” is added to a token before a token to which a next start tag “BEGIN_” is added as one word. Accordingly, the item classification apparatus may recognize the character string 740 of a tokenization unit from the continuous character string 710.

Thus, according to the method disclosed in FIG. 7, the item classification apparatus may classify the information about the item after identifying each token included in the information about the item.

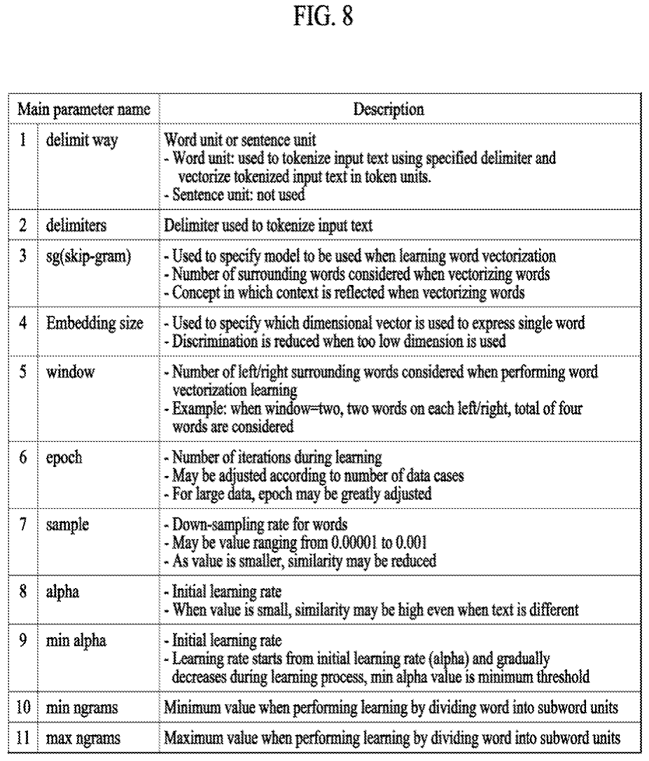

FIG. 8 is a diagram for describing parameters that may be adjusted when a learning model related to the item classification is created, according to an example embodiment.

Meanwhile, the method of classifying an item according to an example embodiment may be improved in performance by adjusting the parameters. Referring to FIG. 8, the method of classifying an item may adjust from a first parameter “delimit way” to an eleventh parameter “max ngrams” according to system design requirements. Among these, from a fifth parameter “window” to the eleventh parameter “max ngrams” may be relatively frequently adjusted in the method of classifying an item according to an example embodiment.

For example, when a tenth parameter “min ngrams” is two and the eleventh parameter “max ngrams” is five, which may mean that a single word is divided into two, three, four, and five character units and is learned and then vectorized.

Meanwhile, the parameters that may be adjusted for the method of classifying information about an item are not limited to those in FIG. 8, and it is clear for those skilled in the art that the parameters may be changed according to system design requirements.

Meanwhile, in the example embodiment, after the learning model is generated, when an accuracy of a result of processing item data through the learning model is reduced, a new learning model may be generated or additional learning may be performed by adjusting at least one of the above parameters. The learning model may be updated or newly generated by performing at least one of the parameters so as to correspond to the description of FIG. 8. For example, when providing information about one or more items each satisfying a similarity criterion, there is a need to modify a weight, which applied to each of a plurality of attributes, in a case in which a plurality of items satisfying the similarity criterion are identified. According to an example embodiment, it is possible to specify in advance which weight is given to which attribute through a configuration, and a size of the weight may be differently specified according to a section to which the number of attributes according to the item information belongs. For example, as the number of size attributes increases, a weight value for the size attribute may be specified to be high. In this case, at least one of the parameters related to the weight may be modified to reconstruct the learning model.

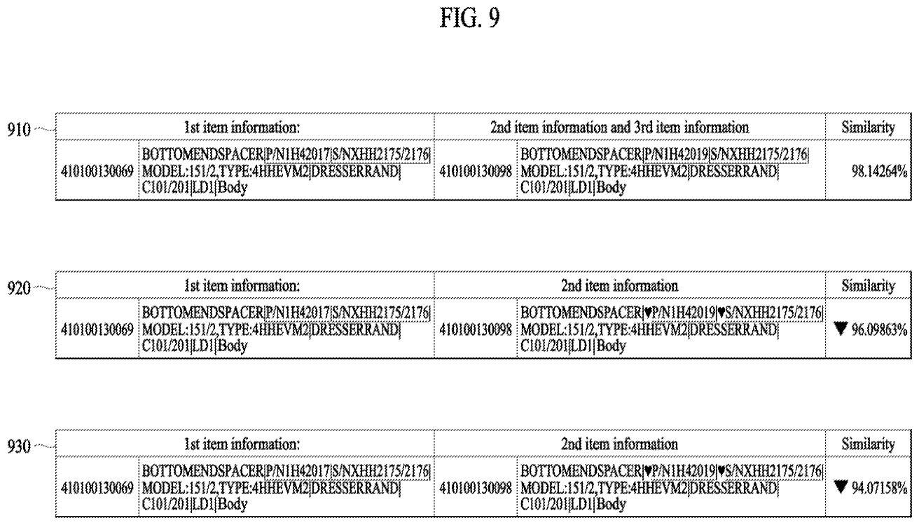

FIGS. 9 to 11 are diagrams for describing a similarity result of items according to an example embodiment.

An apparatus for classifying an item according to an example embodiment may generate a vector after assigning a weight to each attribute included in the information about the item, and based on this, the apparatus for classifying an item may calculate a similarity. At this time, when values of attribute items, to which a relatively high weight is applied, among attribute information included in information about two items are different, a similarity between the information about the two items may be lowered. In contrast, when the values of the attribute items to which a relatively high weight is applied are the same, the similarity between the information about the two items may be increased.

Table 910 illustrates a result of calculating a similarity between information about a first item and information about a second item in a case in which a weight is not reflected in each attribute entry, and tables 920 and 930 illustrate results of calculating a similarity between the information about the first item and the information about the second item after weights are assigned to entries of a part number “P/N” and a serial number “S/N.” Further, the weight assigned to the items of the part number “P/N” and the serial number “S/N” in table 920 is greater than the weight assigned to the items of the part number “P/N” and the serial number “S/N” of table 930.

First, it may be seen that a similarity result of each of tables 920 and 930 is lower than that of table 910 because the part numbers “P/N,” to which the weight is assigned, are different. In addition, it may be seen that the overall similarity result of table 930 is relatively lower than that of table 920 because the weight assigned to the part number “P/N” of table 930 is greater than the weight assigned to the part number “P/N” of table 920.

The influence of the weight is reduced in the similarity result calculated by the item classification apparatus according to an example embodiment as the number of attribute entries included in the information about the item increases. Accordingly, the item classification apparatus according to an example embodiment may assign a greater weight to some attribute entries included in the information about the corresponding item as the number of the attribute entries included in the information about an item increases.

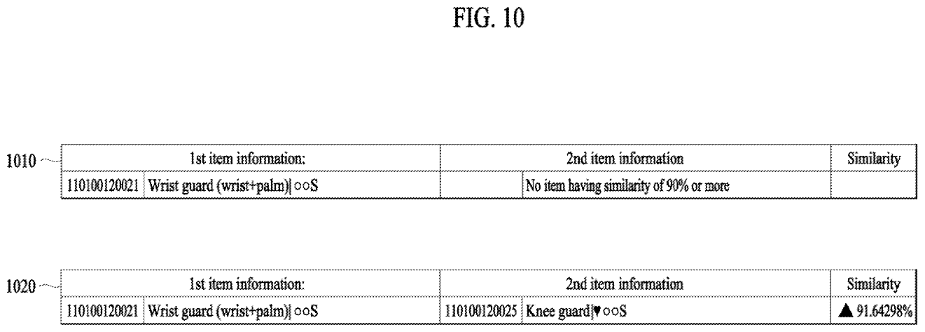

Meanwhile, referring to tables 1010 and 1020 of FIG. 10, it may be seen that a weight is assigned to an attribute entry “OTOS” shown after a special symbol. At this time, since the number of attribute entries included in each of information about a first item and information about a second item is two, which is a relatively small number, the similarity result may vary significantly depending on whether the attribute entries to which a weight is assigned are the same. Meanwhile, table 1020 illustrates the similarity between the information about the first item and the information about the second item, which have the same attribute and to which the weight is assigned, and the similarity result may be significantly increased as compared to a case in which the weight is not assigned.

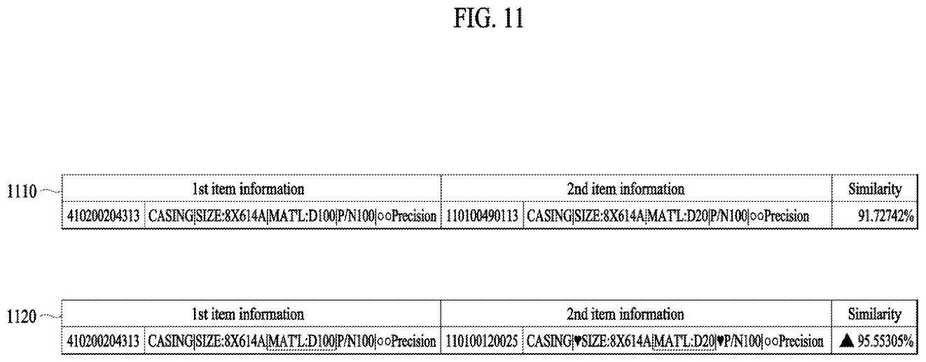

Referring to tables 1110 and 1120 of FIG. 11, it may be seen that a weight is assigned to attributes of a size “size” and a part number “P/N” shown after a special symbol. At this time, when information about a first item and information about a second item are different in a material attribute entry to which a weight is not assigned, a similarity between the two information may increase as compared to a case in which the weight is not assigned.

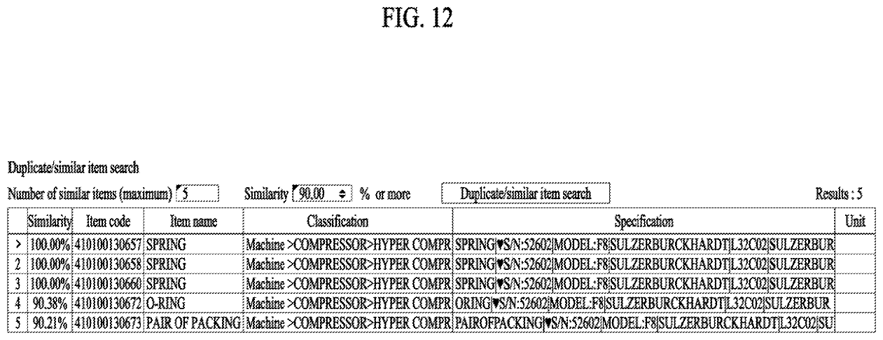

FIG. 12 is a diagram for describing a method of providing information about similar items according to an example embodiment.

According to an example embodiment, a similar item information providing apparatus may generate a target vector on the basis of a character string corresponding to information about a target item using a learning model. In addition, the generated target vector is compared with vector sets, each of which corresponds to each of a plurality of items and is derived previously through a learning model, and information about one or more items each corresponding to a vector having a similarity value greater than or equal to a threshold value among the vector sets may be provided. Alternatively, the information about one or more items corresponding to the vector having the similarity value greater than or equal to the threshold value among the vector sets may be provided as many as less than or equal to a certain number of items. At this time, when the number of the information about the items each corresponding to the vector having the similarity value greater than or equal to the threshold value is greater than or equal to a preset number of items, the information about the items corresponding to the vector may be provided as many as a certain number of items in a descending order of the similarity values. For example, the item information corresponding to the vector having a similarity value of 90% or more with the vector corresponding to the information about the target item among the vector sets may be provided as many as upper five items.

When the number of the information about the item corresponding to the vector having the similarity value greater than or equal to the threshold value among the vector sets is less than the preset number of items, only the checked item information may be provided, or the threshold value may be adjusted. For example, when the number of the item information corresponding to the vector having the similarity value of 90% or more with the vector corresponding to the information about the target item among the vector sets is less than five, for example, is three, only three pieces of checked information about the items may be provided, or the threshold value is adjusted to 85% such that the item information corresponding to the vector having a similarity value of 85% or more may be provided as many as upper five items. Such a similarity threshold value and the number of items, which may be provided, may be set by the user or set by the system.

In FIG. 12, the user designates the similarity threshold value and the number of items to be provided. For example, the user sets the maximum number of similar items to five, and wants to receive item information having the similarity value of 90% or more.

On the basis of such a set value, upper five item information among the item information corresponding to the vector having the similarity value of 90% or more may be exposed. In FIG. 12, the information about the items each corresponding to a vector having a similarity value of 100%, that is, a vector that is the same as that of the target item are provided as many as three, and the information about the items corresponding to vectors having similarity values of 90.38% and 90.21% in a descending order of the similarities from below 100% are provided.

Meanwhile, a predetermined number or more information about the items each corresponding to a vector having a similarity value greater than or equal to the threshold value may be checked. In this case, the vector values of the items may be reconstructed by modifying weight application criteria, thereby affecting a similarity comparison result. For example, when the number of the item information each corresponding to the vector having the similarity value of 90% or more is checked to be 100 or more, the vector values of the items may be reconstructed by lowering or increasing a weight of specific attribute information. In an example embodiment, the weight application criteria may be modified so that the number of item information each corresponding to the vector having the similarity value of 90% or more is derived to be 15 or less.

According to an example embodiment, the information about one or more items each include a corresponding similarity and recognition code. For example, in FIG. 12, when the information about similar items are provided, a similarity and an item code corresponding to each item may be provided together.

In addition, an item code and an item name, item classification information (a main-category, a sub-category, and a sub-sub-category), specifications, a providing unit, and the like may be included as the information about the item to be provided. Among these, the item name and the item classification information may be the required attribute information related to the item, which has been described with reference to FIG. 2. According to an example embodiment, the information about similar items may be retrieved on the basis of the classification information of the target item, but the similarity may be compared even between items with different classifications.

Meanwhile, of the vectors having the same similarity value among the vectors having the similarity value greater than or equal to the threshold value, there may be a plurality of information about the items having different item codes according to the information about each item. That is, a plurality of item information having the same similarity but different item codes may be identified. In this case, different item codes are assigned to the item information having the same character string, and thus the different item codes need to be processed to be no longer used. To this end, the use of certain item codes may be processed to be suspended with reference to a past usage history of the items. In this case, since the item codes whose use is suspended may also be counted in figures due to the past usage history or the like, a continuously usable item code among the item codes of the same item may be designated as an alternative code so that the item codes whose use is suspended are not omitted in the figures accumulation.

For example, in FIG. 12, item codes may be different for upper three-item information having a similarity value of 100%. Since this is a case in which the item codes are different even though the attribute information about the items, such as the item name, classification, specifications, and the like, are the same, the use of some item codes is required to be suspended. Accordingly, the similar item information providing apparatus may modify the information about the item based on result values.

Meanwhile, even a single piece of information about the item corresponding to the vector having the similarity value greater than or equal to the threshold value may not be checked. In this case, since there is no item information to be provided, an input for a threshold value change may be received. According to an example embodiment, when a similar item is not searched even in spite of the threshold value change, it is assumed that the corresponding item is a new item that does not correspond to previously retained data, and thus a procedure for registering information about the item may be performed.

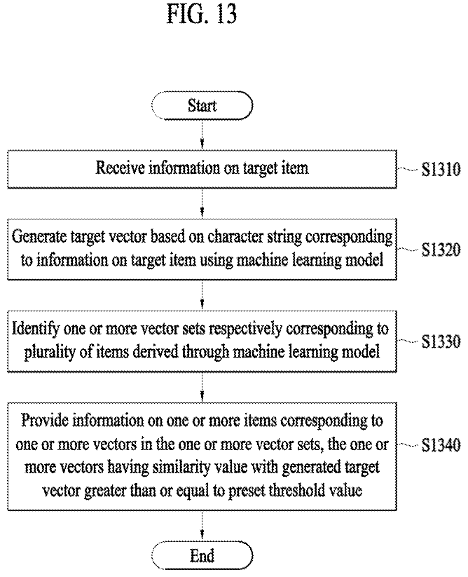

FIG. 13 is a flowchart for describing a method of providing information about similar items based on machine learning according to an example embodiment.

In operation S1310, the method may receive information about a target item. The information about the target item may refer to new item data that has not been previously received or stored. Here, the information about the target item may include information about a plurality of attributes related to the target item. Alternatively, the information about the target item may include required attribute information related to the target item and optional attribute information related to the target item. Meanwhile, while receiving the information about the target item in operation S1310, pre-processing of removing characters irrelevant to similarity analysis from the received information about the target item may be performed. At this time, a character string corresponding to the information about the target item may be generated on the basis of information derived according to a result of the pre-processing.

In operation S1320, the method may generate a target vector on the basis of the character string corresponding to the information about the target item using a machine learning model. According to an example embodiment, the character string may be generated by concatenating at least some of information about the plurality of attributes on the basis of the order according to the learning model. Alternatively, the character string may be generated concatenating at least some of the optional attribute information and the required attribute information depending on the order according to the learning model. In this case, a delimiter may be included between each attribute information in the character string. Meanwhile, when information about a specific order among the order according to the learning model is not input in the information about the target item, the character string may be generated by including a character corresponding to a space character in the specific order. A character corresponding to the space character may be a predetermined character, for example, may be “0”. By configuring the character string as described above, a similarity determination may be performed for a character, which is not input, without additional consideration.

According to an example embodiment, in order to generate a target vector, a sub-word vector corresponding to a sub-word having a length less than that of information about each of the plurality of attributes included in the character string may be generated using the machine learning model. In addition, on the basis of the created sub-word vector, a word vector corresponding to the information about each of the plurality of attributes and a sentence vector corresponding to the information about the target item may be generated. Here, the word vector may be generated on the basis of at least one of a sum or average of the sub-word vectors. In the example embodiment, when the summing or averaging of the vectors is performed, a weight may be applied to each vector, and the weight applied may be changed depending on a learning result or a user input, and the vector to be applied may also be changed.

Meanwhile, assigning a weight to the information about each of the plurality of attributes may be included before performing operation S1220, and here, the sentence vector may be changed depending on the weight. In addition, the weight may be changed depending on the number of attribute items included in the pieces of information about the items.

In operation S1330, the method may identify one or more vector sets respectively corresponding to a plurality of items derived through the machine learning model. The vector set in this case may be a set of vectors generated through machine learning for the entire item master.

In operation S1340, the method may provide information about one or more items respectively corresponding to one or more vectors whose similarity value with a target vector created from one or more vector sets is greater than or equal to a preset threshold value. In other words, by comparing the target vector of the target item with the vectors included in the vector set, at least one item information corresponding to at least one vector having a similarity value greater than or equal to the preset threshold value may be provided as similar item information related to the target item. The information about one or more items may each include a corresponding similarity and recognition code.

According to an example embodiment, the information about the items each corresponding to the vector having the similarity value greater than or equal to the preset threshold value among the information about one or more items may be provided to be less than a preset number of items. At this time, when the information about the items each corresponding to the vector having the similarity value greater than or equal to the preset threshold value is greater than or equal to the preset number of items, the information about the items corresponding to the vector may be provided as many as the preset number of items in a descending order of the similarity values.

Meanwhile, among the vectors having the similarity value greater than or equal to the preset threshold value, a plurality of information about the items corresponding to the vectors having the same similarity value and having different recognition codes according to the information about each item may be checked. In this case, a recognition code of each of the information about the plurality of items may be modified and stored in a database.

Alternatively, when the number of the information about one or more items respectively corresponding to one or more vectors having the similarity value greater than or equal to the preset threshold value is checked to be greater than or equal to a preset number in operation S1340, the weight may be modified. That is, when a plurality of item information corresponding to the vector having a similarity value greater than or equal to a specific value are checked, the weight may be modified. In addition, the machine learning model may be reconstructed using the modified weight.

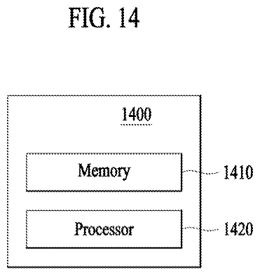

FIG. 14 is a block diagram for describing an apparatus for providing information about similar items based on machine learning according to an example embodiment. A similar item information providing apparatus 1400 according to the present disclosure is an apparatus that encompasses the above-described item classification apparatus, and may perform an operation of the item classification apparatus.

The similar item information providing apparatus 1400 may include a memory 1410 and a processor 1420, according to an example embodiment. The similar item information providing apparatus 1400 shown in FIG. 14 is illustrated with only components that are related to the present example embodiment. Accordingly, it will be understood by those of ordinary skill in the art that other general components may be further included in addition to the components illustrated in FIG. 14.

The memory 1410 may be hardware for storing various pieces of data processed in the similar item information providing apparatus 1400, for example, the memory 1410 may store data processed and data to be processed by the similar item information providing apparatus 1400. The memory 1410 may store at least one instruction for the operation of the processor 1420. In addition, the memory 1410 may store programs, applications, and the like that are to be driven by the similar item information providing apparatus 1400. The memory 1410 may include random access memory (RAM) such as dynamic random access memory (DRAM) or static random access memory (SRAM), read-only memory (ROM), electrically erasable programmable read-only memory (EEPROM), CD-ROM, Blu-Ray® or other optical disk storage, hard disk drive (HDD), solid state drive (SSD), or flash memory.

The processor 1420 may control the overall operation of the similar item information providing apparatus 1400 and process data and signals. The processor 1420 may generally control the similar item information providing apparatus 1400 by executing at least one instruction or at least one program stored in the memory 1410. The processor 1420 may be implemented as a central processing unit (CPU), a graphics processing unit (GPU), an application processor (AP), or the like, but the present disclosure is not limited thereto.

The processor 1420 may receive information about a target item. The information about the target item may refer to new item data that has not been previously received or stored. Here, the information about the target item may include information about a plurality of attributes related to the target item. Alternatively, the information about the target item may include required attribute information related to the target item and optional attribute information related to the target item. Meanwhile, while receiving the information about the target item, the processor 1420 may perform pre-processing of removing characters irrelevant to similarity analysis from the received information about the target item. At this time, a character string corresponding to the information about the target item may be generated on the basis of information derived according to a result of the pre-processing.

The processor 1420 may generate a target vector on the basis of the character string corresponding to the information about the target item using a machine learning model. According to an example embodiment, the character string may be generated by concatenating at least some pieces of information about the plurality of attributes on the basis of the order according to the learning model. Alternatively, the character string may be generated concatenating at least some of the optional attribute information and the required attribute information depending on the order according to the learning model. In this case, a delimiter may be included between each attribute information in the character string. Meanwhile, when information about a specific order among the order according to the learning model is not input in the information about the target item, the character string may be generated by including a character corresponding to a space character in the specific order.

According to an example embodiment, in order to generate a target vector, the processor 1420 may generate a sub-word vector corresponding to a sub-word having a length less than that of information about each of the plurality of attributes included in the character string using the machine learning model. In addition, on the basis of the generated sub-word vector, a word vector corresponding to the information about each of the plurality of attributes and a sentence vector corresponding to the information about the target item may be generated. Here, the word vector may be created on the basis of at least one of a sum or average of the sub-word vectors. In the example embodiment, when the processor 1420 performs the summing or averaging of the vectors, a weight may be applied to each vector, and the weight applied may be changed depending on a learning result or a user input, and the vector to be applied may also be changed.

Meanwhile, the processor 1420 may assign a weight to the information about each of the plurality of attributes, and here, the sentence vector may be changed depending on the weight. In addition, the weight may be changed depending on the number of attribute items included in the information about the items.

The processor 1420 may identify one or more vector sets respectively corresponding to a plurality of items derived through the machine learning model. The vector set in this case may be a set of vectors generated through machine learning for the entire item master.

The processor 1420 may provide information about one or more items respectively corresponding to one or more vectors whose similarity value with a target vector created from one or more vector sets is greater than or equal to a preset threshold value. In other words, by comparing the target vector of the target item with the vectors included in the vector set, the processor 1420 may provide at least one item information corresponding to at least one vector having a similarity value greater than or equal to the preset threshold value as similar item information related to the target item. The information about one or more items may each include a corresponding similarity and recognition code.

According to an example embodiment, the processor 1420 may provide the information about the items each corresponding to the vector having the similarity value greater than or equal to the preset threshold value among the information about one or more items to be less than a preset number of items. At this time, when the information about the items each corresponding to the vector having the similarity value greater than or equal to the preset threshold value is greater than or equal to the preset number of items, the processor 1420 may provide the information about the items corresponding to the vector as many as the preset number of items in a descending order of the similarity values.

Meanwhile, among the vectors having the similarity value greater than or equal to the preset threshold value, a plurality of information about the items corresponding to the vectors having the same similarity value and having different recognition codes according to the information about each item may be checked. In this case, the processor 1420 may modify a recognition code of each of information about the plurality of items and store the recognition code in a database.

Alternatively, when the number of the information about one or more items respectively corresponding to one or more vectors having the similarity value greater than or equal to the preset threshold value is checked to be greater than or equal to a preset number, the processor 1420 may modify the weight. That is, when a plurality of item information corresponding to the vector having a similarity value greater than or equal to a specific value are checked, the processor 1420 may modify the weight. In addition, the machine learning model may be reconstructed using the modified weight.

The apparatus according to the example embodiments described above may include a processor, a memory for storing and executing program data, a permanent storage such as a disk drive, a communication port for communicating with external devices, and user interface devices, such as a touch panel, keys, buttons, and the like. Methods may be implemented with software modules or algorithms and may be stored as program instructions or computer-readable codes executable on a processor on a computer-readable recording medium. Examples of the computer-readable recording medium include magnetic storage media (e.g., read-only memory (ROM), random-access memory (RAM), floppy disks, hard disks, and the like), optical recording media (e.g., CD-ROMs, or digital versatile discs (DVDs)), and the like. The computer-readable recording medium may also be distributed over network coupled computer systems so that the computer-readable codes are stored and executed in a distributive manner. The media may be readable by the computer, stored in the memory, and executed by the processor.

The present example embodiment may be described in terms of functional block components and various processing operations. Such functional blocks may be implemented by any number of hardware and/or software components configured to perform the specified functions. For example, these example embodiments may employ various integrated circuit (IC) components, e.g., memory elements, processing elements, logic elements, look-up tables, and the like, which may perform various functions under the control of one or more microprocessors or other control devices. Similarly, where components are implemented using software programming or software components, the present example embodiments may be implemented with any programming or scripting language including C, C++, Java, Python, or the like, with the various algorithms being implemented with any combination of data structures, processes, routines or other programming components. However, such languages are not limited, and program languages that may be used to implement machine learning may be variously used. Functional aspects may be implemented in algorithms that are executed on one or more processors. In addition, the present example embodiment may employ conventional techniques for electronics environment setting, signal processing and/or data processing, and the like. The terms “mechanism,” “element,” “means,” “configuration,” and the like may be used in a broad sense and are not limited to mechanical or physical components. The term may include the meaning of a series of routines of software in conjunction with a processor or the like.

The above-described example embodiments are merely examples and other example embodiments may be implemented within the scope of the following claims.

What is claimed is:

1. A method of providing information on similar items based on machine learning, the method comprising:
receiving information on a target item;
generating a target vector based on a character string corresponding to the information on the target item using a machine learning model;
identifying one or more vector sets respectively corresponding to a plurality of items derived through the machine learning model; and
providing information on one or more items corresponding to one or more vectors in the one or more vector sets, the one or more vectors having a similarity value with the generated target vector greater than or equal to a preset threshold value.

2. The method of claim 1, wherein:
the receiving of the information on the target item comprises receiving information on a plurality of attributes related to the target item, and
the character string is generated by concatenating at least some of information on the plurality of attributes based on an order according to the learning model.

3. The method of claim 1, wherein:
the receiving of the information on the target item comprises receiving required attribute information of the target item and optional attribute information of the target item,
the character string is generated by concatenating the required attribute information and at least some of the optional attribute information depending on an order according to the learning model, and
a delimiter is included between each of the required attribute information and the at least some of the optional attribute information.

4. The method of claim 3, wherein when information on a specific order among the order according to the learning model is not input in the information on the target item, the character string is created by including a character corresponding to a space character in the specific order.

5. The method of claim 1, wherein:
the receiving of the information on the target item comprises pre-processing by removing characters irrelevant to similarity analysis from among the received information on the target item, and
the character string is generated on the basis of information derived according to a result of the pre-processing.

6. The method of claim 1, wherein the providing of the information on one or more items comprises providing information on items corresponding to vectors having the similarity value greater than or equal to the preset threshold value, from among the information on one or more items, to less than or equal to a preset number of items.

7. The method of claim 6, wherein, when the number of the information on the items corresponding to the vectors having the similarity value equal to or greater than the preset threshold value is greater than or equal to the preset number of items, the information on the corresponding items are provided as many as the preset number of items in a descending order of the similarity values.

8. The method of claim 6, further comprising:
when information on a plurality of items, which correspond to the vectors having the same similarity value among the vectors having the similarity value greater than or equal to the preset threshold value and have different recognition codes according to the information on each item, are identified, suspending the use of at least one recognition code among the different recognition codes.

9. The method of claim 1, wherein the generating of the target vector comprises:
generating a sub-word vector corresponding to a sub-word having a length less than that of each of information on a plurality of attributes included in the character string using the machine learning model; and
generating a word vector corresponding to each of the information on the plurality of attributes and a sentence vector corresponding to the information on the target item, based on the sub-word vector.

10. The method of claim 9, further comprising:
assigning, prior to using the machine learning model, a weight to each of the information on the plurality of attributes,
wherein the sentence vector is generated according to the weight.

11. The method of claim 10, in the provision of the information on one or more items, when the number of the information on one or more items corresponding to one or more vectors having the similarity value greater than or equal to the preset threshold value is identified to be greater than or equal to a preset number, the method further comprising:
modifying the weight; and
reconstructing the machine learning model by using the modified weight.

12. The method of claim 1, wherein each of the information on one or more items includes a corresponding similarity value and recognition code.

13. An apparatus for providing information on similar items based on machine learning, the apparatus comprising:
a memory configured to store at least one instruction; and
a processor,
wherein the processor is configured to execute the at least one instruction to:
receive information on a target item;
generate a target vector based on a character string corresponding to the information on the target item using a machine learning model;
identify one or more vector sets respectively corresponding to a plurality of items derived through the machine learning model; and
provide information on one or more items corresponding to one or more vectors in the one or more vector sets, the one or more vector having similarity value with the generated target vector greater than or equal to a first threshold value.

14. A computer-readable non-transitory recording medium comprising a computer program for executing a method of providing information on similar items based on machine learning, wherein the method of providing information on similar items based on machine learning comprises:
receiving information on a target item;
generating a target vector based on a character string corresponding to the information on the target item using a machine learning model;
identifying one or more vector sets respectively corresponding to a plurality of items derived through the machine learning model; and
providing information on one or more items corresponding to one or more vectors in the one or more vector sets, the one or more vector having similarity value with the generated target vector greater than or equal to a first threshold value.
